(19) United States
(12) Patent Application Publication
(10) Pub. No.: US 2015/0100365 A1
(43) Pub. Date: Apr. 9, 2015

(54) CONSTRAINT OPTIMIZATION METHOD AND SYSTEM FOR SUPPLY CHAIN MANAGEMENT

(71) Applicant: Elemica, Inc., Exton, PA (US)

(72) Inventors: Ben TORKIAN, Atlanta, GA (US); Armand CASTRO, III, Atlanta, GA (US); Cindi HANE, Atlanta, GA (US); Nathan BLOMQUIST, Atlanta, GA (US)

(21) Appl. No.: 14/449,766

(22) Filed: Aug. 1, 2014

Related U.S. Application Data
(60) Provisional application No. 61/887,715, filed on Oct. 7, 2013.

(51) Int. Cl. G06Q 10/08; G06Q 10/10

(52) U.S. Cl. CPC G06Q 10/083; G06Q 10/1095
USPC 705/7.19

(57) ABSTRACT

A method of determining availability of a plurality of loading points for an appointment to be scheduled, wherein the availability of each loading point is variably constrained based upon attributes of the appointment and availability of other resources. The preferred method comprises determining a plurality of constraints related to the loading point and to the attributes of the appointment to be scheduled, deriving, from the plurality of constraints related to the loading point and to the attributes of the appointment to be scheduled, a plurality of binary temporal constraint masks, and combining the masks of the plurality of binary temporal constraint masks to create a binary temporal availability mask. The method may present availability of at least one loading point of the plurality of loading points, wherein the presented availability of the loading point is derived from the binary temporal availability mask for the loading point.

### CROSS-REFERENCE TO RELATED APPLICATION

This application claims the benefit under 35 U.S.C. §119(e) of U.S. Provisional Patent Application No. 61/887,715, filed Oct. 7, 2013.

### BACKGROUND OF THE INVENTION

Scheduling shipments in a supply chain to transport goods between sellers and buyers is a complicated process. Several third party carriers may be employed to transport goods from the seller or manufacturer to the buyer, including air carriers, ground carriers, ocean carriers, or various combinations of these carriers. In addition, further variables must be managed including time slots, product quantities, product volumes, special shipping requirements such as refrigeration, fragile item handling, storage, labor outages, and numerous other shipping constraints. These multiple variables and/or constraints in a supply chain often create significant uncertainty and planning complications for supply chain participants.

Supply chain management was traditionally managed exclusively by manual techniques and only recently has been at least partially automated such that sellers, buyers, manufacturers, carriers and other supply chain participants could potentially connect to a central server to submit capabilities to the central server. The central server may provide solutions to supply chain participants for shipping goods through feasibility techniques based on participant constraint inputs. These techniques are often limited and time consuming, in that they sequentially check constraints to eliminate unworkable solutions. Even on modern high-speed computer systems, the number and nature of constraints can make determination of available options using traditional algorithms impractical.

It would be desirable to design and implement a system and method for managing a supply chain that improves the operation of the computer systems and provides prompt solutions to supply chain scheduling with constraints and variables including time, carrier preferences, special goods and similar variables and constraints.

### BRIEF SUMMARY OF THE INVENTION

A method of determining availability of a plurality of loading points for an appointment to be scheduled, wherein the availability of each loading point is variably constrained based upon attributes of the appointment and availability of other resources. The preferred method comprises determining a plurality of constraints related to the loading point and to the attributes of the appointment to be scheduled, deriving, from the plurality of constraints related to the loading point and to the attributes of the appointment to be scheduled, a plurality of binary temporal constraint masks, and combining the masks of the plurality of binary temporal constraint masks to create a binary temporal availability mask. The method may present availability of at least one loading point of the plurality of loading points, wherein the presented availability of the loading point is derived from the binary temporal availability mask for the loading point.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram showing a system for efficiently developing solutions for a constrained supply chain event utilizing a central database having stored information related to capabilities of a plurality of market participants in accordance with a preferred embodiment of the present invention;

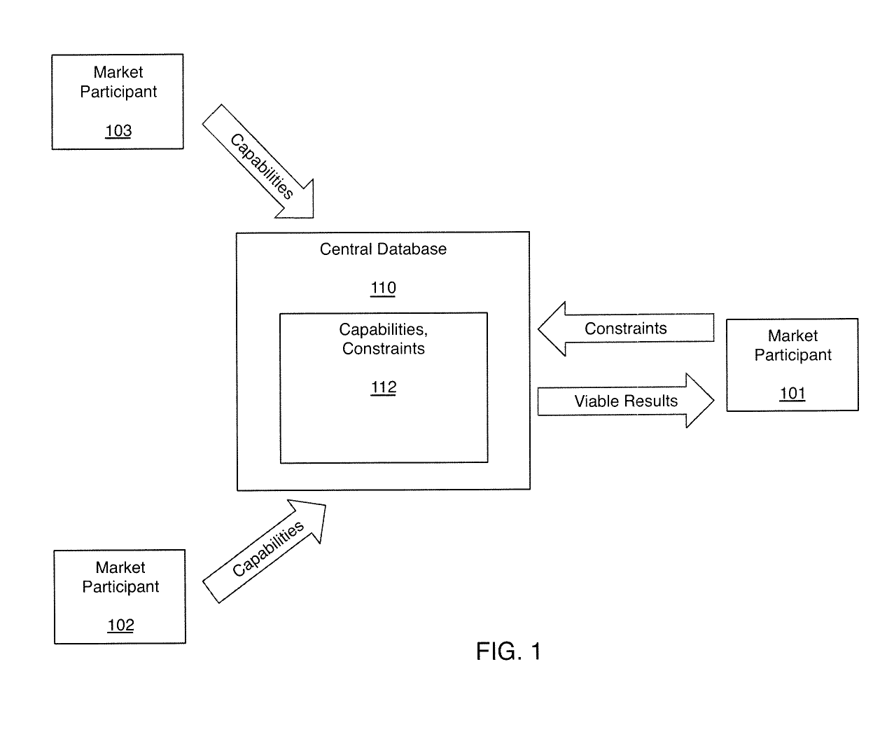

FIG. 2 is a high-level sequence diagram of the process of obtaining time availability for a supply chain appointment in the system of FIG. 1;

FIG. 3 is an illustration of a shipping environment for use in discussion of the operation of the present system and methods of FIG. 1;

FIG. 4 is an illustration of a high-level process 400 for determining the viable timeslots for resources such as a loading point in the system of FIG. 1;

FIG. 5 is a flow chart of an exemplary process 500 for determining the availability of a particular top-level resource, such as a loading point 310a-b, 320a-b, or 330a-d in the system of FIG. 1;

FIG. 6 is an illustration of the process of determining the availability mask for a top-level resource in the system of FIG. 1;

FIG. 7 is an illustration of the dependence of the binary temporal constraint mask on task length in the system of FIG. 1;

FIG. 8 is an illustration of the calculation of a mask of timeslot availability based upon staff availability

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right,” “left,” “lower,” and “upper” designate directions in the drawings to which reference is made. The words “inwardly” or “distally” and “outwardly” or “proximally” refer to directions toward and away from, respectively, the geometric center or orientation of the system and related parts thereof. The terminology includes the above-listed words, derivatives thereof and words of similar import.

A preferred embodiment of the present invention is directed to a system and method for efficiently developing solutions to a constrained event. The event of the preferred embodiment is preferably a supply chain event. However, the present application is not so limited and the system and method may be utilized with nearly any variety of event wherein viable solutions to constrained events are desired, such as selecting a viable airline flight, selecting various travel accommodations and/or transportation for a constrained trip, coordinating repairs and maintenance for a power plant shutdown and other like constrained events.

A preferred embodiment is directed toward scheduling of shipping appointments such as pickups and drop-offs of shipments at loading points. In the preferred embodiment, constraints related to the scheduling of an appointment at each loading point are converted to a plurality of binary temporal constraint masks with each binary value in the mask indicating whether the associated constraints allow or prevent scheduling of an appointment beginning at that time. These binary temporal constraint masks are then combined to create an overall availability mask for a particular loading point. Information derived from one or more availability masks may then be presented to the user to allow selection of an appointment time for scheduling.

The preferred system utilizes a central database 110 having stored information 112 related to capabilities and constraints of a plurality of market participants 101, 102, 103. The system or network of the preferred embodiment preferably has a large number of market participants 101, 102, 103 that are able to communicate through the central database 110 to facilitate coordination between the market participants 101, 102, 103 in completing events. For example, the market participants 101, 102, 103 may communicate with each other through the central database 110 to facilitate shipping of product from a first market participant 101 to a second market participant 102 with the third market participant 103 acting as a carrier or shipper to transport the product of the first market participant 101 to the second market participant 102. Additional constraints may be derived by the system based upon information regarding the event to be scheduled. For instance, information regarding a product to be shipped and the quantity of that product may create or affect constraints related to viable loading points or the time required for a pickup or delivery appointment.

In the preferred system, the central database 110 receives a plurality of constraints related to the supply chain event of a requesting market participant 101, 102, 103 and the plurality of constraints are preferably stored with the stored information 112. Constraints may comprise information regarding loading point availability, product availability, business hours, staff availability, time required for various tasks and the distribution of that required time, as well as any other factors that may impact the ability of the task to be scheduled to be performed at a particular time.

The preferred system is able to solve for viable times for heavily constrained events by breaking the constraints into constraint segments, which are concurrently solved and combined. A plurality of viable solutions or choices are calculated based on the plurality of constraint segments based in the stored information 112 and the plurality of constraints received from the market participant 101, 102, 103. The viable solutions or choices are filtered resulting in a plurality of viable results that are transmitted to the requesting market participant 101, 102, 103. The requesting market participant 101, 102, 103 is then able to elect their desired viable choice or solution from the first and second viable choices.

The system may determine that no viable choices are available for the specifically constrained event, thereby resulting in the system notifying the requesting market participant 101, 102, 103 that no viable choices are available for the particularly constrained event and certain constraints should be modified to relax the constraints. In addition, the system the system may determine that only a single viable choice is available for a particularly constrained event and the single viable choice is preferably transmitted to the requesting market participant for election or rejection. Similarly, the system is not limited to transmitting or calculating only the first and second viable choices, as the system may determine that numerous additional viable choices are available for a particular constrained event and each of the viable choices may be transmitted to the requesting market participant 101, 102, 103 for election or rejection. Further, the system may be configured such that all viable choices are not transmitted to the requesting market participant 101, 102, 103 and the transmitted viable choices may be limited to a specific number of transmitted viable choices or the system may permit the requesting market participant 101, 102, 103 to constrain the results such that a specific number of viable choices are transmitted for selection purposes.

In a preferred embodiment, the system receives the plurality of viable results and transmits information related to the supply chain event to the requesting market participant 101, 102, 103. Accordingly, the system preferably transmits more than just the viable result to the requesting market participant 101, 102, 103, but also transmits instructions related to the viable result and supply chain event such that the requesting market participant is able to make an informed decision when determining if or which viable result to elect or implement. For example, the system may transmit identification information, credit worthiness, timing, or other related information to the requesting market participant to assist the requesting market participant in electing one of the viable results that are transmitted based upon the various constraints.

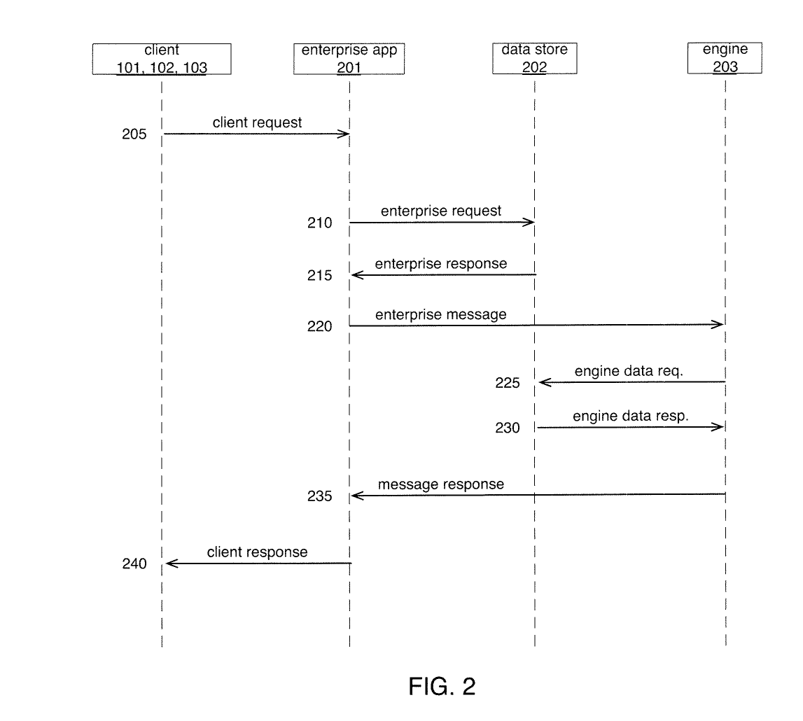

FIG. 2 is a high-level sequence diagram of the process of obtaining time availability for a supply chain appointment to be scheduled. The preferred central database 110 includes an enterprise application 201 to interface with the market participant 101, 102, or 103, such as a carrier/shipper or client, a data store 202 and an engine 203. The preferred engine 203 includes a message queue, a master data portion, a validation state, a filter, a map and a reduction stage.

The preferred system provides responses to the market participant 101, 102, 103 related to booking or scheduling a shipment, booking or scheduling multiple shipments, the feasibility of booking or scheduling shipments, or other related matters. However, the preferred system is not limited to providing responses to shipment related requests and their feasibility and may be utilized to provide responses or feasibility answers to other requests, such as classroom scheduling, student scheduling, patient scheduling, train scheduling, airline scheduling, multi-mode transport scheduling, vendor bidding and other related request responses and/or feasibilities. The preferred system is particularly adept for providing scheduling and/or feasibility for events involving time as a variable. The preferred system is typically able to reduce the number of messages that the market participant must send and receive prior to reaching a feasible solution to their request.

The market participant 101, 102, 103, such as the carrier/shipper or client preferably sends a client request at 205 to the enterprise application 201, which sends information related to the request to the data store 202 at 210. At 215, the data store 202 provides an enterprise response to the enterprise application 201, which, at 220, sends the enterprise message to the engine 203. The enterprise message, sent from the enterprise application 201 to the engine 203, is received and accepted or rejected by the message queue within the engine 203. The engine data request and response is communicated between the data store 202 and the master data portion within the engine 203.

At 225, the engine 203 sends an engine data request to the data store 202, which, at 230, provides an engine data response to the engine 203. At 235, the engine 203 subsequently provides a message response to the enterprise application 201, which, at 240, provides a client response to the market participant 101, 102, 103.

The master data portion of engine 203 checks the data set to ensure that the data required for the request is present. The relevant data is then validated in the validation state, filtered by the filter, mapped with the map and reduced and mapped through several cycles between the map and the reduction stage. In the validation state, the data is checked to ensure the data set includes valid or logical data. For example, if a drop-off location for goods that are being transported requires a forklift for removal from one vessel and transport to another and the elected drop-off location does not have a forklift, the validation state would eliminate the erroneous location and the associated data. In the filter, the data is preferably simplified and/or the proposed response(s) is simplified.

In the several cycles between the map and the reduction stage, the data moves back and forth such that the preferred system is able to optimize the answer or response to the request and/or to optimize multiple answers or responses to the request. The mapped and reduced data is subsequently sent to the filter to again ensure valid, optimal or good results. Following filtering and again mapping, the data is transmitted to the message queue and to the enterprise application 201 for transmittal to the market participant 101, 102, 103. The process of transmitting the client request to receiving the client response preferably occurs in under a second in a preferred system, but is not so limited and may take more or less time to process the request, particularly in consideration of the complexity or intricacy of the request. In a preferred embodiment, determination of available appointment times occurs in “real time,” such that the user perceives the response to his or her request to be essentially immediate.

In the preferred embodiment, the requesting market participant 101, 102, 103 may be a carrier, a supplier, a manufacturer and a buyer. These particular preferred requesting market participants 101, 102, 103 are known in supply chain events and are not meant to be limiting. For example, the requesting market participant may be comprised of any actor or company that is able to present to transmit constraints for a particular event and receive viable results from the system. The requesting market participant 101, 102, 103 of the preferred system may include consumers, supply management personnel, tracking entities, consignees, storage facilities, or nearly any other entity that participates in a market or is involved in a market where constrained events occur.

In the preferred embodiment, typical constraints may include time, storage, operating times, appointments or potential appointment timeframes spanning one or more days, hours of operation, block time, previous appointments, intervals, fixed or variable durations, reservations, negative reservations, goods, volumes, release times, times, preferences, prices, subcarrier release times, subcarrier frozen times, preferences, requirements to combine shipments, requirements related to the type of party, fixed calculations, quantity-based calculations including step-functions, timeframes, large slot than shipment, product outages and product groups. Constraints are not limited to these listed constraints of the preferred system and may be comprised of nearly and type and/or variety of constraint that places constraint and/or limits on a particular event and is typically related to the type of event that the market participant 101, 102, 103 expects or desires to constrain.

The central database 110 may preferably be implemented using commodity computing hardware comprising one or more processors, solid state or rotating drives, RAM, and other components. In a preferred embodiment, central database 110 may also comprise web servers, load balancers, and other components to facilitate access to the data therein. In some embodiments, one or more components, particularly engine 203, may comprise specialized hardware for performing high volumes of computational tasks relevant to the method, such as the various bitwise algorithms described below.

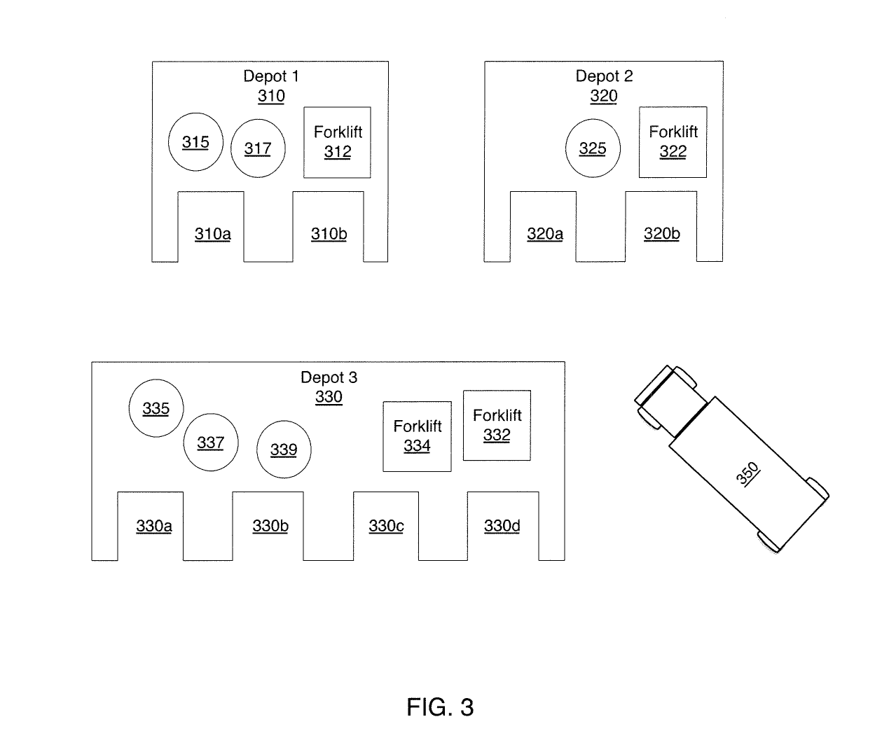

FIG. 3 is an illustration of a shipping environment for use in discussion of the operation of the present system and methods. The illustration is merely an example to illuminate discussion of the present system and methods and is not intended to limit the scope of the invention. It is to be understood that while small numbers of each resource are shown in the example and few resource constraints exist between them, the present system is adapted to handle situations with hundreds or thousands of resources with tens, hundreds, or even thousands of interrelated constraints.

In the example, three depots 310, 320, and 330 are located at various geographic locations. Each depot comprises a number of loading points, or loading docks 310a-b, 320a-b, 330a-d for accepting a shipping vehicle such as truck 350. Staff 315 and 317 work at depot 1 310. Staff 325 works at depot 2 320. Staff 335, 337, and 339 work at depot 3 330. Forklift 312 is present at depot 1 310. Forklift 322 is present at depot 2 320. Forklifts 332 and 334 are present at depot 3 330. In the present example, staff and equipment are shared as needed amongst the depot loading points. However, some resources may be associated with a single loading point or a subset of loading points.

In the present example, a carrier operating truck 350 is to pick up an order from a supplier operating depots 310, 320, and 330. The supplier will generally require the carrier to set an appointment for the pickup, to ensure that the carrier arrives at a time when a loading point is available with a needed equipment and staff and where the product to be shipped is available.

The supplier may provide a system for making appointments, such as a web site accessible by carrier 350. Carrier 350 may have preferences with regard to location and time of pickup. The supplier may only have the needed product available at a subset of the depots 310, 320, 330. Furthermore, other resources, such as personnel and equipment may only be available at certain times at various depots. Additionally, loading points and resources may not be available at certain times due to other activities, such as existing appointment reservations or expected breaks, vacations, maintenance, or outages. The result is that a large number of constraints may be placed on the scheduling of the appointment, making determination of available appointment times for selection a complicated task. In a preferred embodiment, a core portion of the system provides an application programming interface (API) that can be made available to a variety of software clients, such as web sites, mobile device applications, and other enterprise systems such as enterprise resource planning (ERP) and supply chain management (SCM) systems.

In such an example, the role of the system is to receive information about constraints associated with the task to be performed, such as a pick up, combine that information with information regarding the interrelated constraints associated with the loading points, and provide information back to the user regarding viable appointment timeslots for at least a subset of those loading points.

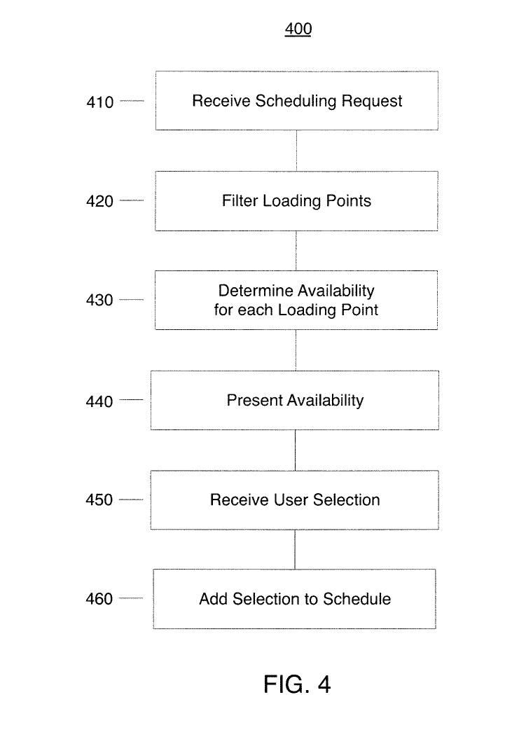

FIG. 4 is an illustration of a high-level process 400 for determining the viable timeslots for resources such as a loading points. While the process is described with respect to assessment of availability of loading points for clarity of description, the process may also be applied to other top-level resources such as medical facilities, conference facilities, recreational facilities, transportation resources, or other resources with variable availability.

At 410, the system receives a scheduling request from a market participant, such as a carrier. The scheduling request may be, for instance, for a pickup or a drop-off of a shipment of goods.

At 420, initial filtering is performed on the top-level resource to be scheduled, such as the loading points. The filtering may be based upon any number of factors such as geographic location, product availability, or ability to accommodate a desired mode of shipping. It is to be understood that filtering may also effectively be performed at the following step using availability constraints. However, processing may be more efficient in some cases if an initial filtering is performed using other methods, such as those that operate directly in the domain in which the constraints are stored, such as calendar time or geographic distance.

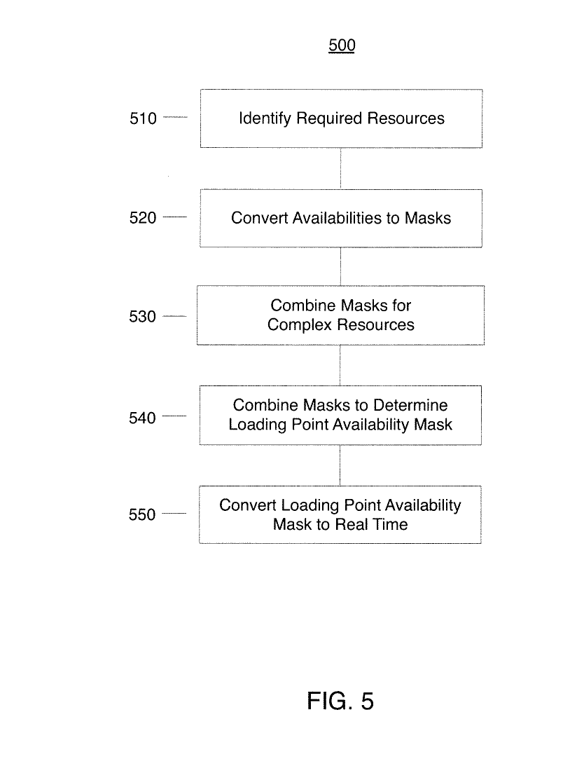

At 430, the availability of each top-level resource, such as each of the loading points meeting the filter criteria of 420, is determined. The availability is determined using a binary temporal constraint mask combination technique describe further below with respect to FIGS. 5-8.

The methods of the present invention may be considered as an instance of the general MapReduce programming model. Various Map procedures are used to convert information relevant to constraints related to the appointment to be scheduled and related to the resources into a set of binary temporal constraint masks related to those constraints.

The mapping from constraints to binary temporal constraint masks may or may not be a one-to-one relationship, depending on the nature of the constraints. In some cases, certain real-world constraints may cause other constraints to be used or not used and not themselves map directly to binary temporal constraint masks. Furthermore, even those constraints that are temporal in nature, such as business hours or times of other appointments, may not directly map to the same time intervals in the corresponding binary temporal constraint masks due to interactions amongst constraints, as will be described below.

The Reduce procedure performs the summary operation of combining the binary temporal constraint masks related to the constraints into an availability mask for each top-level resource, such as a loading point, being considered for use in the appointment to be scheduled.

At 440, the availabilities of appointments for various loading points are presented to the user. The availabilities are preferably presented in terms of real calendar and clock time. In a preferred embodiment, availability is presented visually with loading points presented as columns and time slots represented as rows, with available appointments indicated at appropriate row-column intersections.

At 450, a selection of a particular appointment time for a particular loading point is received from the user. In a preferred embodiment, the selection is made via user selection of an appointment presented at 440.

At 460, the appointment is added to the schedule. Additionally, the availability data for each resource impacted by the appointment, such as the loading point itself, staff, product, and equipment, will be adjusted to account for the expected usage during the newly scheduled appointment. Thus, the newly scheduled appointment will be accounted for as subsequent appointments are scheduled.

FIG. 5 is a flow chart of an exemplary process 500 for determining the availability of a particular top-level resource, such as a loading point 310a-b, 320a-b, or 330a-d. The process 500 may be performed, for instance, at 430 of process of 400 for each loading point meeting the criteria of the filtering of 420. It is to be understood that while the steps are described in a particular order, some steps may be performed in other orders or in parallel. As with the process above, while the process is described with respect to assessment of availability of loading points, the process may also be applied to other top-level resources such as medical facilities, conference facilities, recreational facilities, transportation resources, or other resources with variable availability.

At 510, the supplemental resources required for use of the top-level resource for the required task are identified. For instance, for transfer of pallets, one or more forklifts may be required. For transfer of liquid chemicals, certain pump equipment may be required. Staff may be required at various points before, during, and after the appointment to be scheduled, sometimes in variable numbers.

In some cases, top-level resources may be filtered from consideration prior to process 500, perhaps at 420, based on availability of some key equipment. In other cases, a determined resource mask related to the loading point will cause the top-level resource to appear unavailable.

At 520, the availabilities of resources associated with the top-level resource are converted to masks. For instance, the availability of operators or other staff associated with a loading point, expected outages of product, availability of equipment, and existing reservations, may each be converted from various real-time formats to binary temporal constraint masks. As described earlier, the masks may have arbitrary duration and granularity. In one embodiment, 24-hour durations are used in cases where the relevant time windows are within a single day, and two or more 24-hour durations are combined in cases where an appointment or associated constraints may span timeslots belonging to multiple days.

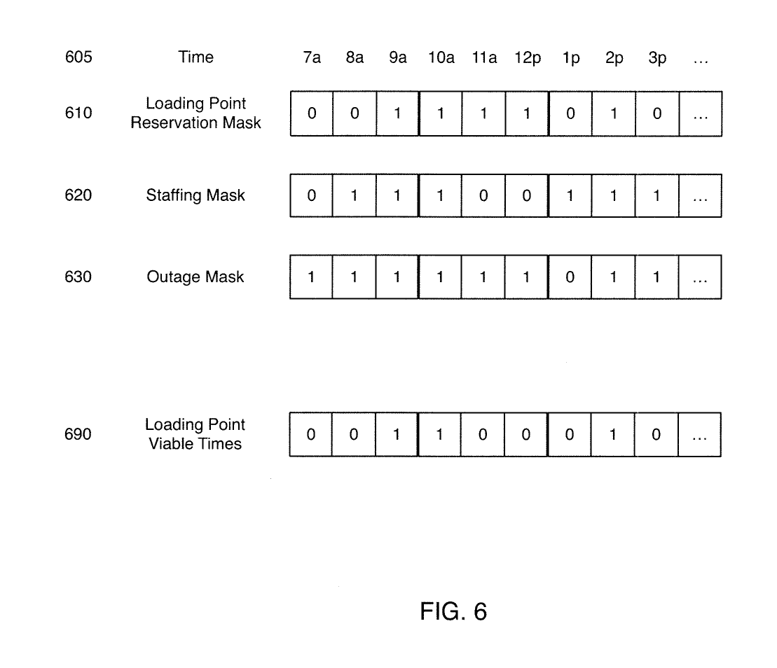

At 530, masks for individual resources of a particular type may be combined to produce a composite resource mask. For instance, if use of a loading point requires two operators, but not specific operators, the masks for all potentially available staff members may be combined in such a way as to produce a composite operator resource mask that indicates times when at least two operators are available. In more complex cases, the individual availabilities of the operators are combined and then thresholded against a time-variable set of values, such that the resulting mask indicates whether sufficient staff would be present at all relevant times before, during, and after the appointment, if the appointment were to begin at the time slot at issue. Examples of this process are described in further detail with respect to FIG. 6 below.

At 540, the availability masks associated with a loading point are combined to produce the loading point availability mask. In a preferred embodiment, this combination is effectively performed as a series of bitwise AND operations. That is, the loading point in question is indicated as available for an appointment starting at a particular time slot if each and every one of the component availability masks has an indication of availability for that time slot.

It is to be understood that while this final combination of masks is preferably an AND operation, other bitwise operations, such as OR, XOR, NOT, NAND, or NOR may be used as needed to reflect the relationships amongst the constraints. For instance, masks of resources that are substitutes for each other may, in some embodiments, be maintained as separate masks up through the final combination step. The engine performing the combination may apply an “OR” to those masks to determine availability of at least one of the resources for scheduling viability, but still maintain the individual masks such that a choice amongst substitutable resources at a selected appointment time may be presented to the user based upon the information contained in the individual resource masks. In one embodiment, an “overlap” mask may be created to indicate those timeslots for which a choice amongst the substitutable resources is available. If an appointment slot is chosen corresponding to a timeslot with a positive indication in the overlap mask, processes may be invoked for providing the opportunity to select amongst those resources. Similarly, more complex logical and arithmetic operations may be used to compute the individual component masks, such as at 530, particularly for multi-resource requirements such as staffing.

At 550, the loading point availability mask is converted back to actual time values or intervals. In some embodiments, this may entail applying an inverse transform of that applied to convert real-time availability data to the binary temporal constraint mask domain. This facilitates presentation of the availability in a format meaningful to the user.

Again, it is to be understood that some of the steps of process 500 may be performed in other orders or in parallel. For instance, step 530, the combining of masks for complex resources, may be performed as part of step 520. Process 500 may further be performed in parallel by a number of processors for a large number of loading points and constraints.

In the preferred embodiment, individual constraints or sets of constraints may be stored in any form. However, to perform the assessment of viability of timeslots for the desired task, the constraints are processed to create binary temporal constraint masks. In the preferred embodiment, the temporal constraint mask for each constraint is a binary mask, with each binary digit representing whether or not that constraint makes scheduling a timeslot starting at that time viable or unviable. As will be described below, the constraints that impact assessment of viability of timeslots and the transformation of those constraints to binary temporal constraint masks may both be affected by aspects of the appointment to be scheduled.

In this simplified example, the activity to be scheduled uses durations equal to the time interval represented by a single binary digit, in this case, an hour. The processes described herein, however, are general and applicable to tasks that span arbitrary time intervals and the masks may similarly have arbitrary granularity.

FIG. 6 is an illustration of the process of determining the availability mask for a top-level resource such as a loading point. A plurality of binary temporal constraint masks 610, 620, and 630 span time intervals 605. In the present example, one-hour time intervals are used. The binary temporal constraint masks are combined using logical AND operations to produce and overall availability mask 690 for a loading point.

In the present simplified example, individual binary temporal constraint masks related to three individual or compound constraints are combined. The first is a loading point reservation mask 610. In this example, the loading point reservation mask 610 indicates that reservations would cause unviability of appointments starting at 9 AM, 10 AM, 11 AM, 12 P or 2 P. It is not necessarily the case that specific reservations are made for each of these times. The mask indicates, however, that for some reason, the constraints related to reservations make beginning an appointment of the nature of the appointment being scheduled not viable to begin at that time slot.

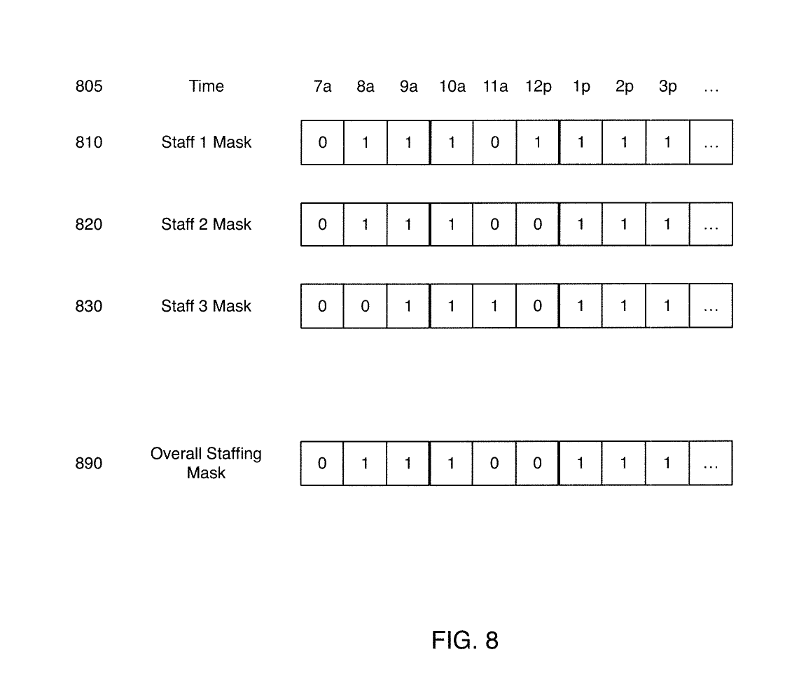

Similarly, staffing mask 620 indicates whether staffing-related constraints make beginning an appointment during a particular time slot viable or not viable. In the case of simple staffing constraints for an appointment lasting less than the duration of a time interval, the mask may be a one-to-one indication of whether a staffer is available at the loading point. In other cases, each bit may indicate whether a sufficient, and potentially variable, number of staff members are available for periods of time extending before, during, and after the appointment, if the appointment were to start during that time interval. Creation of a binary temporal constraint mask related to staffing constraints will be discussed further with respect to FIG. 8. In still other cases, each bit may indicate whether the expected capacity or remaining capacity of a resource, such as storage area or volume, is sufficient for the expected need during one or more timeslots if the appointment is scheduled to start at a given timeslot.

Outage Mask 630 indicates whether constraints related to product outages make starting an appointment of the type being schedule viable or unviable. Many other masks may be generated to represent additional constraints. The constraints and masks shown here are merely exemplary.

In a preferred embodiment, while more complicated transforms may be used to create each individual binary temporal constraint mask, the combined availability mask for the loading point is created using logical AND operations, combining all of the component binary temporal constraint masks into a single mask indicating those time slots for which all of the component masks indicated viability. That is, the combined mask 690 provides an indication of whether all constraints are met for a particular time slot, thereby making an appointment starting at that time viable. In the present example, 9 AM, 10 AM, and 2 PM are determined as viable start times for the specific type of appointment at this particular loading point.

It is notable that in the preferred embodiment, the combination engine may operate with no particular knowledge of the relationship of the masks to real time, either in extent or interval size. Since all constraints will have been converted to the same binary temporal constraint mask domain, they may be combined without this knowledge.

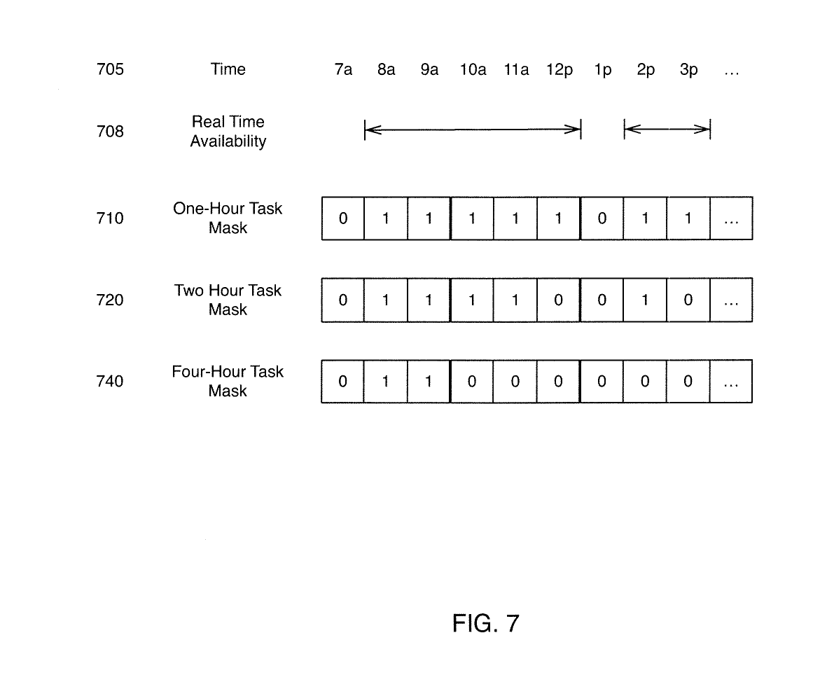

FIG. 7 is an illustration of the dependence of the binary temporal constraint mask on task length. The temporal constraint mask computed at 520 for a resource will often vary based upon the duration of the task to be performed that will utilize the resource. If a task takes more than one binary temporal mask time interval, multiple consecutive time intervals will need to be available for that resource for that time interval to be marked as a viable start time in the resulting mask.

The time required for a task may be computed in a number of ways. In some cases, the required time may be a constant. In others, the duration may be dependent upon a quantity associated with the appointment, such as the quantity of goods to be transferred. In some cases, the time may rise as a step function. For instance, if each pallet requires a certain amount of time for loading, the number of pallets required may determine the time rather than the exact quantity.

In the illustrated example 700, time 705 is broken into one-hour segments. The real time availability 708 for a particular resource comprises the time intervals from 8 AM through the noon, a five-hour span, as well as the 2 PM-3 PM intervals, a two-hour span.

If the task for which the binary temporal constraint mask is to be computed consumes one hour, the resulting binary temporal constraint mask for the resource would indicate availability at each increment for which there is availability indicated in the real time availability 708. If the task requires one hour and the time increments are an hour, any time at which the resource is available will be indicated as a viable start time for the appointment with respect to that resource in the mask 710.

If the task for which the binary temporal constraint mask is to be computed consumes two hours, the resulting binary temporal constraint mask 720 for the resource would indicate availability at each increment for which there is availability indicated in the real time availability 708 for both that hour and the next hour, as shown in mask 720.

If the task for which the binary temporal constraint mask is to be computed consumes four hours, the resulting binary temporal constraint mask 740 for the resource would indicate availability as a starting time at each increment for which there is availability indicated in the real time availability 708 for both that hour and the next three hours.

It is to be understood that this is a simplified example for purposes of illustration. A preferred embodiment of the system is adapted to facilitate use of business logic for many types of constraints, some interrelated. A common attribute of each constraint conversion process, however, is to represent the constraint or combination of constraints in a common domain in which a positive value at a particular bit position indicates that the constraints do not prevent an appointment beginning at the time represented by that position, and a negative value indicates that the constraints do prevent an appointment beginning at that time.

FIG. 8 is an illustration of the calculation of a mask of timeslot availability based upon staff availability. In many cases, more than one of a certain type of resource, such as staff or equipment, may be required for a task. For instance, in a very simple case, a task may need to be staffed by two human operators.

In the present example, across time intervals 805, three staff members have individual availability masks 810, 820, and 830. In this example, the task requires two staff members for the time period to be viable. The task in this case is assumed, for simplicity of explanation, to require a single time interval.

The overall staffing mask 890 therefore indicates viability of a starting time for all time periods for which at least two of the individual staff masks 810, 820, 830 indicate availability. Computationally, this operation may be performed, for instance, as a bitwise summing and thresholding. That is, if the bit values for a particular time interval are summed across a time slot for all instances of the fungible resource and the result meets or exceeds the threshold, that bit position may be noted as a positive value in the composite mask for that fungible resource.

In some instances, the level of staffing of the loading point required for viability of a timeslot will not be constant. For instance, additional staff may be needed before or at the time of arrival of the carrier, but not during the majority of the loading time itself. In this case, a sliding set of adjustment values may be applied to the bitwise sums. The sliding set of adjustment values may extend before and after the appointment window. For instance, if three operators are required for an hour before an appointment to prepare a loading point, but only one operator is required during the appointment window, a sliding set of adjustment values of “2000,” with second position corresponding to the start time, may be used to adjust the bitwise sums. Alternatively, both the general threshold (e.g., the staffing offset and the variability) may be encoded in the same threshold string.

In essence, the mapping process from constraints and rules to a binary temporal constraint masks simplifies the information to answer the question, “are there are enough people at all relevant times to start an appointment at this time?” Thus, multiple bitwise addition and threshold operations may need to be performed at a variety of other time interval bit positions to determine each individual value of the composite resource mask. The bit position of the composite resource mask only being set to a positive value if all of the individual sums meet their respective thresholds.

A similar process may be utilized for resources having fixed or variable capacity, such as storage areas or storage tanks. The expected available capacity of each resource at each timeslot may be represented by, for instance, an integer value. The required storage capacity at a given time or set of times may be compared with the expected available capacity for a single resource or the aggregate available capacity of a set of resources, to determine a binary temporal availability mask for the required storage resource.

Many other types of constraints may be applied using the system in addition to those described above. In some cases, a shipper may need to make an appointment for pickup of multiple products or a product or shipment comprising multiple components. In such a case, the availability of each loading point for each individual product or component may be computed as described above. The resulting availability masks for each product in the set of products may then be combined using bitwise AND to determine availability for the multi-product appointment.

Another type of constraint that may impact the determination of available appointment times is a reservation. In a preferred embodiment of the system, certain time periods for certain loading points may be allocated ahead of scheduling of appointments to certain carriers. The system will first attempt to find appointments during the times reserved for the carrier. If no times are available within the reserved time period, the system may then expand the results to include times outside the reserved times.

The system may use, for example, one of two mechanisms to achieve this result. First, the system may apply the reservation periods for each loading point as a constraint. The binary temporal constraint mask for the reservation would be combined with the other constraints at 540 and impact the resulting availability mask for the loading point. The disadvantage of this approach, however, is that if no viable appointments remain with the reservation constraints applied, the process would need to be executed a second time without the reservation constraints. Thus, a second method may be used in which the availability for each loading point is computed without using reservations as a constraint, with the reservation periods applied as a filter before display of the results after computation of the availability mask.

In a preferred embodiment, reservations may be “cleared” if the remaining time until the reserved period is below a certain threshold. That is, if the intended carrier has not utilized the reservation, the time slot may be opened to other carriers. This may be implemented as an adjustment to a constraint or to a filter.

Appointment slots may be frozen at a certain time, such as a number of hours before the appointment slot or, for instance, a certain time on the day before the appointment slot. The “frozen” time may vary based upon whether the user is related to a carrier, subcarrier, shipper, or other role.

In a preferred embodiment, negative reservations may also be configured. That is, certain time slots may be reserved for all but the carrier associated with the negative reservation. Negative reservations, like positive reservations, may be implemented either via binary temporal constraint masks or as filters.

In a preferred embodiment, the system schedules based on 24-hour periods. That is, each constraint is converted to a binary temporal constraint mask spanning a 24-hour period at whatever temporal granularity is in use. For instance, with hourly granularity, each mask would be represented by a 24-bit sequence. For minute-level granularity, each mask would be represented by a 1440-bit sequence. While arbitrary lengths could be used, particularly lengths based on a temporal filter such as a desired window for the appointment, standardizing the corresponding real-time length of the binary temporal constraint masks can simplify the program code. Results, however, are generally filtered such that less than the entire 24-hour-period is presented to the user, based on factors such as the period during which appointment availability was queried, user interface configuration, user preferences, or other factors.

The system is not limited to scheduling within a one-day period, however. Appointments that span more than a day, or appointments that cross midnight between days may be scheduled. In the preferred embodiment, however, the 24-hour periods on each side of each day threshold would be assessed separately, with the results combined for presentation.

The system will preferably comprise user interfaces for setting and viewing preferences related to appointment viability determinations. Preferences may include, for instance, settings for the time interval to be used, reservations, negative reservations, staffing, outages, calculation methods for durations (e.g., fixed, quantity based, step function), calculation methods for staffing requirements, pre-appointment resource requirements, business hours, holidays, and other factors that may impact scheduling.

The system may also provide the ability to configure times at which various parties may schedule appointments. For instance, in a preferred embodiment, carriers may be provided the ability to book appointments only up to three days ahead, whereas shippers may be allowed to book at any time. Further constraints may be set for sub-carriers. The system may also provide the ability to freeze the ability to make appointments for imminent time periods, such as the next day, at a particular time. Whether the user account is associated with a shipper, carrier, or subcarrier may be considered as a constraint by the system, affecting the number and content of the binary temporal constrain masks. The type of user may therefore cause other constraints to be applied.

In a preferred embodiment, the system provides the ability for a user to search for times at which an already scheduled shipment may be rescheduled. While this could be accomplished by canceling the existing appointment and performing a new search, that approach risks the current appointment slot being booked by another party or the system preventing rebooking of the same appointment based on other constraints. In order to accurately perform this task without risking loss of the present appointment, the system must account for those resources marked for expected use by the presently scheduled appointment in calculating availability of other appointments. This may be accomplished in a variety of ways, such as adding the staff to be used by the current appointment to the remaining staffing counts, reversing the availability of resources used by appointment to be rescheduled, such as the loading point or equipment before combination of the temporal masks, etc. In essence, availability of other appointment slots is calculated as if the currently scheduled appointment was canceled, but without performing the cancellation until after a new appointment time is selected.

The system is preferably integrated with enterprise resource planning (ERP) or supply chain management (SCM) software. Shippers and carriers may automatically receive notification of shipments to be scheduled, preferably including links to bring the user to an interface to determine available appointment times.

Since the binary temporal constraint masks for a constraint may depend on aspects of a shipment that are not known ahead of time, a preferred embodiment of the system generates the binary temporal constraint masks on-the-fly once details of the appointment to be scheduled are known. Constraints may be stored in disparate formats, though many may be stored as time intervals in normal time format, along with associated rules. For instance, availability of a particular staff member may be stored as start and end times of portions of a work shift. Rules, however, would specify that the staff member is needed fifteen minutes prior to the start time of an appointment for the appointment to be viable, which may cause the binary temporal constraint mask to deviate from a simple mapping of the time intervals to the binary temporal constraint mask domain.

By applying the described methods, appointments involving far more complex combinations of constraints may be determined in real time. While a conventional constraint satisfaction problem (CSP) approach may test essentially every permutation of resources to locate one solution, the present methods simultaneously provide an indication of all of the appointment times that are viable solutions. While the time required for a CSP approach may grow exponentially as constraints are added, the time required for the present methods grows essentially linearly.

In practice, the above techniques have been shown to produce results in seconds in situations where constraint satisfaction problem techniques require hours. Thus, the described methods provide not only a vastly improved user experience, but also cost savings in terms of computing hardware and operation.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention as defined by the present disclosure.

We claim:

1. A method of determining availability of a plurality of loading points for an appointment to be scheduled, wherein the availability of each loading point is variably constrained based upon attributes of the appointment to be scheduled and availability of other resources associated with the loading point, comprising:
for each loading point of the plurality of loading points:
determining a plurality of constraints related to the loading point and to the attributes of the appointment to be scheduled;
deriving, from the plurality of constraints related to the loading point and to the attributes of the appointment to be scheduled, a plurality of binary temporal constraint masks; and
combining the masks of the plurality of binary temporal constraint masks to create a binary temporal availability mask for the loading point; and
presenting information regarding availability of at least one loading point of the plurality of loading points to a user, wherein the presented information regarding availability of the at least one loading point of the plurality of loading points is derived from the binary temporal availability mask for the at least one loading point.

2. The method of claim 1 wherein each bit of each binary temporal constraint mask indicates the viability of the timeslot represented by that bit position with respect to meeting the constraints used in deriving that binary temporal constraint mask.

3. The method of claim 1 wherein the attributes of the appointment to be scheduled comprise at least one of a quantity of a product, a type of product, a computed loading time for the product.

4. The method of claim 1 wherein a constraint representing the length of the appointment to be scheduled is computed based upon a quantity of a product to be transferred.

5. The method of claim 4 wherein computing the length of the appointment based upon a quantity of a product to be transferred comprises applying a step-function.

6. The method of claim 1 wherein combining the masks of the plurality of binary temporal constraint masks to create a binary temporal availability mask for the loading point comprises computation of one or more bitwise AND operations upon the plurality of binary temporal constraint masks, such that a bit of the binary temporal availability mask is set to a value of one only if each and every binary temporal constraint mask of the plurality of binary temporal constraint masks has a value of one at the corresponding bit position.

7. The method of claim 1 wherein combining the masks of the plurality of binary temporal constraint masks to create a binary temporal availability mask for the loading point comprises computation of one or more bitwise AND operations and at least one bitwise OR operation upon the plurality of binary temporal constraint masks.

8. The method of claim 1 wherein each binary temporal constraint mask and binary temporal availability mask comprises the same number of bits representing the same timespan.

9. The method of claim 8 wherein the timespan represented by each binary temporal constraint mask is a day and each bit of each binary temporal constraint mask represents one of a second, a minute, ten minutes, fifteen minutes, thirty minutes, or an hour.

10. The method of claim 1 wherein the availability bit value at each bit position of the temporal availability mask is determined based upon availability of a corresponding resource at the time represented by the bit position and upon availability of the corresponding resource during at least one other time interval, wherein the at least one other time is determined based upon attributes of the appointment to be scheduled.

11. The method of claim 10 wherein the bit position of the temporal availability mask represents a potential start time for the appointment to be scheduled and the at least one other time is prior to the time interval represented by the bit position.

12. The method of claim 1 wherein at least one of the binary temporal constraint masks of said plurality of binary temporal constraint masks is computed using one or more bitwise OR operations upon bitwise temporal constraint masks for individual interchangeable resources.

13. The method of claim 1 wherein at least one of the binary temporal constraint masks of said plurality of binary temporal constraint masks is computed using one or more bitwise sum-and-threshold operations upon bitwise temporal constraint masks for individual interchangeable resources for which more than one resource is required during at least one time period associated with the appointment.

14. The method of claim 1 wherein the number of binary temporal constraint masks is smaller than the number of constraints.

15. The method of claim 1 wherein the plurality of loading points for which availability is to be determined is determined based upon a filter comprising at least one of a geographic limitation, product availability information, or preference information.

17. The method of claim 1 further comprising: receiving an indication of a user selection of an appointment time from appointment times presented as a part of the presented information regarding availability of at least one loading point.

18. The method of claim 1 further comprising: responsive to receiving an indication of a user selection of an appointment time, presenting to the user a set of available options associated with at least one resource associated with the appointment time.

19. The method of claim 1, wherein the plurality of constraints include at least one of time, storage availability, operating times, availability of goods, volume, release time, frozen time, preferences, price, subcarrier release time, subcarrier frozen time, preference, same shipment constraints, fixed time calculation, timeframe, product outage, and product grouping.

20. The method of claim 1 further comprising: converting the binary availability mask for the loading point into data representing time local to either the user or to the respective loading point.
